(19) United States
(12) Patent Application Publication
(10) Pub. No.: US 2014/0095384 A1
(43) Pub. Date: Apr. 3, 2014

(54) Systems and Methods For In Store Shopping With Instant Cash

(71) Applicant: Javed Basha, Bandimote (IN)

(72) Inventor: Javed Basha, Bandimote (IN)

(21) Appl. No.: 13/630,508

(22) Filed: Sep. 28, 2012

(51) Int. Cl. G06Q 20/40

(52) U.S. Cl. 705/44

(57) ABSTRACT

Systems and methods are disclosed herein for a buyer who does not have an immediate source of funds to request funds in the form of instant cash from a third party account holder of a payment service provider for use in making purchases. The buyer may receive the pre-authorized instant cash in the form of a coupon code from the payment service provider on a mobile device. The seller, who has an account with the payment service provider, may transmit the coupon code and a security code to the payment service provider to request approval for the payment. When approved, the payment service provider may deduct a purchase amount from a balance in the instant cash and credit the amount to the seller's account. Advantageously, the buyer and the seller may easily and securely conduct business transactions even when the buyer does not have an immediate source of funds.

### TECHNICAL FIELD

The present disclosure relates generally to systems and methods to facilitate purchase transactions between consumers and merchants. In particular, the present disclosure relates to methods and systems for consumers without cash or a funding source to obtain funds to pay for in-store purchases using a mobile device

### BACKGROUND

Shoppers may go shopping with no funds or insufficient funds to pay for purchases. For example, shoppers may go window shopping with little or no cash and may not have any funding sources such as a credit card, a debit card, or an account with a payment service provider to pay for purchases. As such, when a shopper without an immediate source of funds comes across merchandise that the shopper is interested in buying, the shopper would be unable to make the purchase transaction. The merchant would also lose the opportunity to make a sale. Frequently, however, shoppers may carry a mobile device such as a smartphone. Therefore, it is desirable for shoppers to be able to use a mobile device to obtain an immediate source of funds to enable the shoppers to make in-store purchase transactions.

### BRIEF DESCRIPTION OF THE DRAWINGS

FIG. 1 shows a system for a buyer to use a mobile device to obtain immediate funds from an account holder of a payment service provider and to use the funds to make purchases from a seller according to one or more embodiments of the present disclosure;

FIG. 2 shows a flow chart of the steps for a buyer to request instant cash from an account belonging to an account holder of a payment service provider using a mobile device and to use the instant cash to make a purchase from a seller according to one or more embodiments of the present disclosure;

FIG. 3 shows a flow chart of the steps for an account holder of a payment service provider to request instant cash from the payment service provider for use by a buyer according to one or more embodiments of the present disclosure;

FIG. 4 shows a flow chart of the steps for a payment service provider to receive a request from an account holder to authorize instant cash for use by a buyer and to receive a request from a seller requesting approval for use of the instant cash by the buyer according to one or more embodiments of the present disclosure;

FIG. 5 shows a flow chart of the steps for a seller to accept instant cash from a buyer for a purchase transaction according to one or more embodiments of the present disclosure; and

FIG. 6 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein for a buyer who does not have an immediate source of funds to request funds in the form of instant cash from a third party account holder of a payment service provider for use in making purchases. The buyer may, through a request authorized by the third party account holder, receive the pre-authorized instant cash in the form of a coupon code from the payment service provider on a mobile device. The instant cash may be provided by a payment service provider such as PayPal, Inc. of San Jose, Calif. The instant cash may be accepted as a payment instrument for making purchases when the coupon code is authenticated. The payment service provider may authenticate the coupon code using a security code that is associated with the coupon code. For example, the buyer may tender the coupon code of the instant cash and the security code to a seller as a payment for a purchase. The seller, who has an account with the payment service provider, may transmit the coupon code and the security code to the payment service provider to request payment using the instant cash. In other examples, the payment service provider may authenticate the coupon code using a device identifier of a mobile device or an account from which the payment request is initiated. After the payment service provider authenticates the coupon code to approve the payment request, the payment service provider may deduct a purchase amount from a balance in the instant cash and credit the purchase amount to the seller's account. If there is a balance remaining in the instant cash after the payment deduction, the payment service provider may generate a new coupon code for transmission to the buyer's mobile device so that the pre-authorized amount of instant cash may be used for multiple purchase transactions. Advantageously, the buyer and the seller may easily and securely conduct business transactions even when the buyer does not have an immediate source of funds.

In accordance with one or more embodiments of the present disclosure, an apparatus of a service provider is disclosed. The apparatus includes a network interface that communicates with devices over a network. The apparatus also includes a memory that stores machine-readable instructions. The apparatus further includes one or more processors that execute the machine-readable instructions to receive from a payer, who has an account with the service provider, a funding request to authorize funds for use by a buyer. The processors also process the funding request to generate a coupon code used to identify the funds associated with the payer account. The processors further transmit to the buyer or the payer the coupon code. The processors further receive a payment request to transfer a payment amount from the funds to an account of a seller. The payment request includes the coupon code. The processors further verify the coupon code to approve the payment request. The processors further transfer the payment amount from the funds to the account of the seller. The processors further notify the seller.

In accordance with one or more embodiments of the present disclosure, a method is disclosed. The method includes receiving by the processor of a service provider a funding request from a payer to authorize funds for use by a buyer. The payer is an account holder with the service provider. The method also includes processing the funding request to generate a coupon code used to identify the funds associated with the payer account. The method further includes transmitting to the buyer or the payer the coupon code. The method further includes receiving a payment request to transfer a payment amount from the funds to an account of a seller. The payment request includes the coupon code. The method further includes verifying the coupon code to approve the payment request. The method further includes transferring the payment amount from the funds to the account of the seller. The method further includes notifying the seller.

In accordance with one or more embodiments of the present disclosure, a non-transitory computer readable medium having computer readable code for execution by a processor of a service provider to perform a method is disclosed. The method includes receiving a funding request from a payer to authorize funds for use by a buyer. The payer is an account holder with the service provider. The method also includes processing the funding request to generate a coupon code used to identify the funds associated with the payer account. The method further includes transmitting to the buyer or the payer the coupon code. The method further includes receiving a payment request to transfer a payment amount from the funds to an account of a seller. The payment request includes the coupon code. The method further includes verifying the coupon code to approve the payment request. The method further includes transferring the payment amount from the funds to the account of the seller. The method further includes notifying the seller.

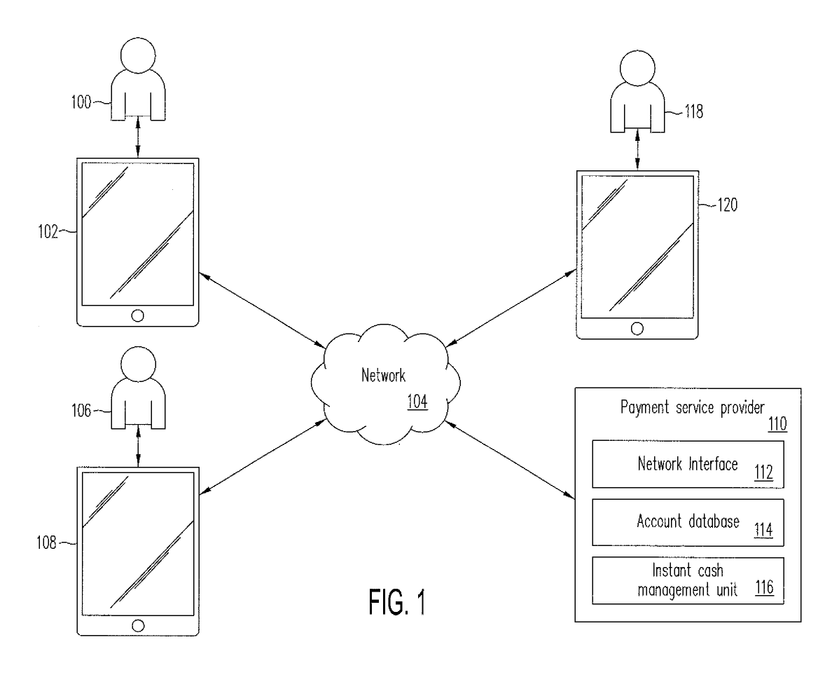

Refer now to the figures wherein the drawings are for purposes of illustrating embodiments of the present disclosure only, and not for purposes of limiting the same. FIG. 1 shows a system for a buyer to use a mobile device to obtain immediate funds from an account holder of a payment service provider and to use the funds to make purchases from a seller according to one or more embodiments of the present disclosure.

A buyer 100 carries a mobile device 102 on a shopping trip. Mobile device 102 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. It should be appreciated that mobile device 102 may be referred to as a client device or a customer device without departing from the scope of the present disclosure. Mobile device 102 may communicate over a network 104 with a payment service provider 110 or with other mobile devices.

Network 104 may be implemented as a single network or a combination of multiple networks. For example, in various embodiments, network 120 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, mobile device 102 may be associated with a particular link (e.g., a link, such as a URL (Uniform Resource Locator) to an IP (Internet Protocol) address).

Buyer 100 may have little or no cash and may not have any immediate funding sources such as a credit card, a debit card, or an account with a payment service provider to pay for purchases. When buyer 100 sees merchandise that he or she is interested in purchasing, buyer 100 may use mobile device 102 to communicate with a payer 106 who has an account with payment service provider 110. Payer 106 may be a family member, a friend, or someone who is willing to provide funds from his/her account for use by buyer 100. Buyer 100 may request that payer 106 authorize an amount of funds equal to the price of the merchandise or an amount to be used for multiple purchases. In one or more embodiments, the account of payer 106 may be authorized to provide a set amount or may place a restriction on the maximum amount for buyer 100. Buyer 100 and payer 106 may agree on a security code such as a Personal Identification Number (PIN) that may be used by payment service provider 110 to authenticate use of the funds by buyer 100 to pay for purchases when a payment request is made. In one or more embodiments, payment service provider 110 may authenticate use of the funds using a device identifier of a device or an account used to initiate the payment request so as to eliminate the need for the security code. Buyer 100 may also communicate to payer 106 the phone number, the IP address, or other identifier of mobile device 102 to which payment service provider 110 may transmit the funds.

Payer 106 may use a mobile device 108 to login to his or her account with payment service provider 110 to request funds for use by buyer 100. The funds may be referred to as instant cash and may be used like cash to pay for merchandise. In one or more embodiments, payer 106 may provide to payment service provider 110 the phone number, the IP address, or other identifier of mobile device 102 of buyer 100 for payment service provider 110 to communicate with buyer 100. In one or more embodiments, payer 106 may request a funding amount. In one or more embodiments, payment service provider 110 may provide a set amount without requiring a funding amount from payer 106 or may cap the funding amount to a maximum amount. In one or more embodiments, payer 106 may provide to payment service provider 110 the security code that will be used for authenticating a payment request using the funds. Payment service provider 110 may verify that payer 106 has sufficient funds in the account or has a line or credit to cover the amount requested. If payment service provider 110 approves the requested amount, payment service provider 110 may generate a coupon code such as a string of alpha-numeric code that will be used to identify the instant cash. Payment service provider 110 may associate the coupon code with the security code as provided by payer 106 for authentication purposes. In one or more embodiments, payment service provider 110 may associate the coupon code with a device identifier of a device that will be used to make a payment request, such as the phone number, the IP address, or other identifier of mobile device 102 of buyer 100. In one or more embodiments, payment service provider 110 may associate the coupon code with account information of a default seller. Payment service provider 110 may transmit to mobile device 102 of buyer 100 and/or to mobile device 108 of buyer 106 the coupon code and information on the instant cash identified by the coupon code, such as the approved amount, the information required to authenticate the coupon code and any validity period. The coupon code, security code, and/or any other desired information may be transmitted in any suitable format that allows seller 118 to read or otherwise capture the information from buyer 100. Examples include a sequence of numbers, characters, letter, and/or symbols or a machine readable image, such as a barcode or QR code. In addition, payment service provider 110 may transmit a confirmation message to mobile device 108 of payer 106 to inform payer 106 that instant cash has been approved and transmitted to buyer 100, and may further provide additional information on the amount of the instant cash approved.

To use funds from the instant cash to pay for merchandise, buyer 100 may provide the coupon code identifying the instant cash to seller 118. In one or more embodiments, buyer 100 may provide the security code associated with the coupon code to seller 118. In one or more embodiments, if seller 118 has an account with payment service provider 110, seller 118 may use seller's mobile device 120 to access the website of payment service provider 110 to login to the seller's account. In one or more embodiments, seller may call payment service provider 110 to access seller's account through a voice response system. If seller 118 does not already have an account with payment service provider 110, seller 118 may be prompted to register an account. Seller 118 may request use of the funds from the instant cash for payment of the merchandise by providing the coupon code identifying the instant cash, and the amount of requested payment to payment service provider 110. In one or more embodiments, payment service provider 110 may authenticate the coupon code using a device identifier of mobile device 120 of seller 118, a point-of-sale terminal, or account information of seller 118. In one or more embodiments, payment service provider 110 may authenticate the coupon code using the security code provided by seller 118. In one or more embodiments, instead of seller 118, buyer 100 may initiate the payment request by calling the payment service provider 110 from mobile device 102 and providing the coupon code and account information of seller 118. Payment service provider 110 may authenticate the coupon code using the phone number, the IP address, or other identifier of mobile device 102 of buyer 100.

Payment service provider 110 may include a network interface 112, an account database 114, and an instant cash management unit 116. Network interface 112 may be the interface through which payment service provider 110 communicates with buyer 100, payer 106, and seller 118. Account database 114 may store account information of payer 106 and seller 118 for account verifications of payer 106 and seller 118 by payment service provider 110 and for verifying that payer 106 has sufficient funds or a line or credit to establish the instant cash. Instant cash management unit 116 may be invoked by payment service provider 110 to process the request for the establishment of the instant cash from payer 106 and to process the request for use of the instant cash for payment from seller 118. For example, payment service provider 110 may invoke instant cash management unit 116 to approve the request from seller 118 to use funds from the instant cash for a purchase payment by verifying that the security code received from seller 118 is associated with the coupon code. Instant cash management unit 116 may further verify that the amount of funds in the instant cash is sufficient to cover the requested payment amount and that the request is received within the validity period of the instant cash, if any.

When payment service provider 110 approves the request for payment using the instant cash, payment service provider 110 may deduct the requested payment amount from the balance in the instant cash and credit the requested payment amount to the account of seller 118. Payment service provider 110 may transmit a confirmation message to mobile device 120 of seller 118 and/or mobile device 102 of buyer 100 to inform seller 118 and/or buyer 100 that the requested payment has been credited to the account of seller 118. When seller 118 receives the confirmation message, seller 118 may complete the sale transaction, such as by handing the merchandise to buyer 100.

If there is a remaining balance in the instant cash after the sale transaction, buyer 100 may desire to use the balance for additional purchases until the balance is exhausted. In one or more embodiments, payment service provider 110 may generate a new coupon code after each sale transaction if there is a non-zero balance remaining in the instant cash. For authentication purposes, the new coupon code may be associated with the same security code used to associate the old coupon code. In one or more embodiments, as with the old coupon code, the new coupon code may be associated with a device identifier of a device that will be used to make a payment request, or with account information of a default seller. Payment service provider 110 may transmit the new coupon code to mobile device 102 of buyer and to provide information on the remaining balance in the instant cash. To purchase additional merchandise from the same seller or a different seller using the balance in the instant cash, buyer 100 may provide the new coupon code and the security code to the seller. Advantageously, buyer 100 may request a pre-authorized amount of instant cash and securely use the instant cash for multiple sale transactions until the instant cash is exhausted.

In one or more embodiments, a validity period may be associated with the instant cash. The coupon code identifying the instant cash may be valid only when used within the validity period. In one or more embodiments, the validity period may be configured by payment service provider 110 or payer 106 to be 12 hours or 24 hours. At the end of the validity period, the coupon code identifying the instant cash may expire and any unused balance in the instant cash may be credited back to the account of payer 106. In one or more embodiments, payer 106 may have the option to revoke the instant cash by canceling the coupon code, such as when the coupon code has been inadvertently generated.

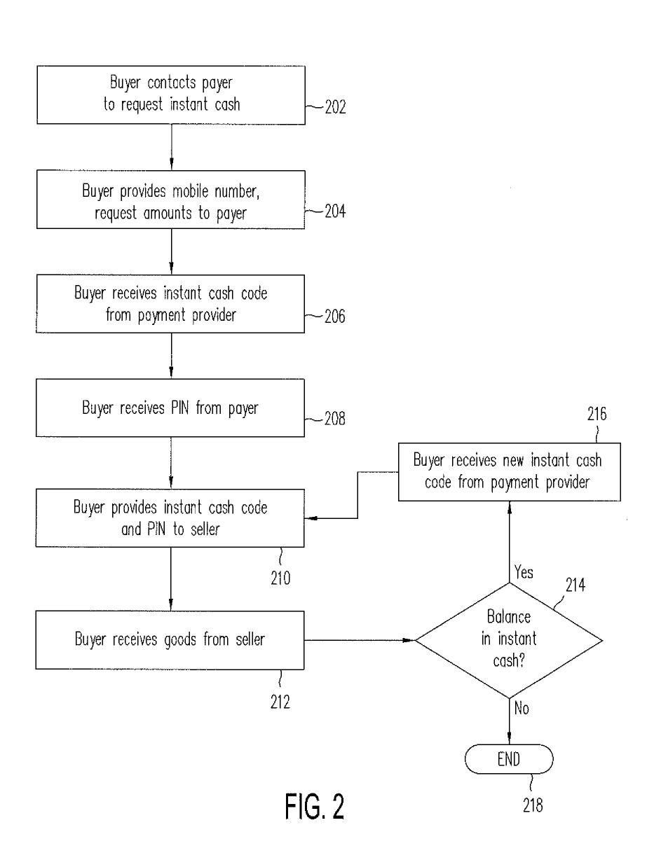

FIG. 2 shows a flow chart of the steps for a buyer to request instant cash from an account holder of a payment service provider using a mobile device and to use the instant cash to make a purchase from a seller of FIG. 1 according to one or more embodiments of the present disclosure. In step 202, buyer 100 uses mobile device 102 to contact payer 106 to request that payer 106 authorizes instant cash for use by buyer 100. For example, buyer 100 may be the wife of payer 106 and may be out shopping but finds herself without sufficient cash and without an immediate source of funds to pay for purchases. Buyer 100 may contact the husband—payer 106, to request that payer 106 authorizes funds from the account of payer 106 with payment service provider 110 for use by buyer 100. In step 204, buyer 100 provides to payer 106 the phone number, the IP address, or other identifier of mobile device 102 and the amount of the pre-authorized funds. Buyer 100 and payer 106 may agree on a security code such as a PIN that will be used to authenticate future use of the funds and may further agree on a validity period for the funds.

Payer 106 may login to his or her account with payment service provider 110 to request that funds be authorized for use by buyer 100. In one or more embodiments, payer 106 may provide to payment service provider 110 the phone number, the IP address, or other identifier of mobile device 102 of buyer 100, the amount of funds requested, the security code, and a validity period for the funds, if any. Payment service provider 110 may use the phone number, the IP address, or other identifier of mobile device 102 to communicate with buyer 100. In one or more embodiments, payment service provider 110 may communicate to buyer 100 through payer 106 so that payer 106 does not need to provide the information of buyer 100 to payment service provider 110. In one or more embodiments, payer 106 may not provide the amount of requested funds because payment service provider 110 may provide a set amount automatically. In one or more embodiments, payer 106 may not provide the security code if use of the funds is authenticated using other information, such as a device identifier of a device used to make a payment request. Payment service provider 110 may approve the request for funds and may generate a coupon code, such as a string of alpha-numeric codes, for identifying the funds. In step 306, buyer 100 receives on mobile device 102 a message from payment service provider 110 informing buyer 100 that funds has been approved for use by buyer 100. The message contains the coupon code, information on the amount of the approved funds, and any validity period for use of the funds. In one or more embodiments, payment service provider 110 may transmit the message to payer 106, who then relays the message to buyer 100. The funds, referred to as instant cash, may be used by buyer 100 to pay for purchases from a seller who has an account with payment service provider 110. In step 208, buyer 100 receives the security code from payer 106 if it is not already known by buyer 100. The security code is associated with the coupon code and is used by payment service provider 110 to authenticate use of the coupon code when tendered as a payment for a purchase. In one or more embodiments, buyer 100 may receive the security code from payment service provider 110.

In step 210, when buyer 110 is ready to make a purchase from seller 118, buyer 110 provides the coupon code to seller 118. In one or more embodiments, when a security code is used to authenticate the coupon code, buyer may also provide the security code to seller 118. Buyer 100 may use mobile device 102 to communicate the coupon code and the security code to mobile device 120 of seller 118 via a text message. Buyer 100 may transmit the desired information in any suitable format that allows seller 118 to read or otherwise capture the information. Examples include a sequence of numbers, characters, letter, and/or symbols or a machine readable image, such as a barcode or QR code. In one or more embodiments, buyer 100 may communicate the information from mobile device 102 to a point-of-sale terminal using near-field communication (NFC), RFID, or other types of short range communication protocols. Seller 118 may login to the seller's account with payment service provider 110 to request payment from the funds identified by the coupon code by providing the coupon code, the security code, and the amount of requested payment. Payment service provider 110 may authenticate the request by verifying that the security code is associated with the coupon code. In one or more embodiments, payment service provider 110 may authenticate the coupon code using a device identifier of mobile device 120 of seller 118, a point-of-sale terminal, or account information of seller 118. In one or more embodiments, instead of seller 118 making the payment request, buyer 100 may initiate the payment request by calling the payment service provider 110 from mobile device 102 and providing the coupon code and account information of seller 118. Payment service provider 110 may authenticate the coupon code using the phone number, the IP address, or other identifier of mobile device 102 of buyer 100. To approve the request, payment service provider 110 may verify that the coupon code has not expired and that the balance in the funds is sufficient to cover the payment request. Payment service provider 110 may deduct the requested payment amount from the balance in the funds and credit the requested payment amount to the account of seller 118. Payment service provider 110 may transmit a confirmation message to mobile device 120 of seller 118 confirming that the requested payment has been made. In step 212, buyer 100 receives merchandise from seller 118 to complete the purchase transaction.

In step 214, if there is a balance in the funds, buyer 100 may desire to use the funds for additional purchases. To provide added security, payment service provider 110 may generate a new coupon code to identify the funds after each use of the funds. In step 216, buyer 100 receives the new coupon code from payment service provider 110. Buyer 100 may present the new coupon code and the security code for a subsequent purchase. Steps 210, 212, 214, 216 may be repeated until the funds are exhausted or the security code has expired.

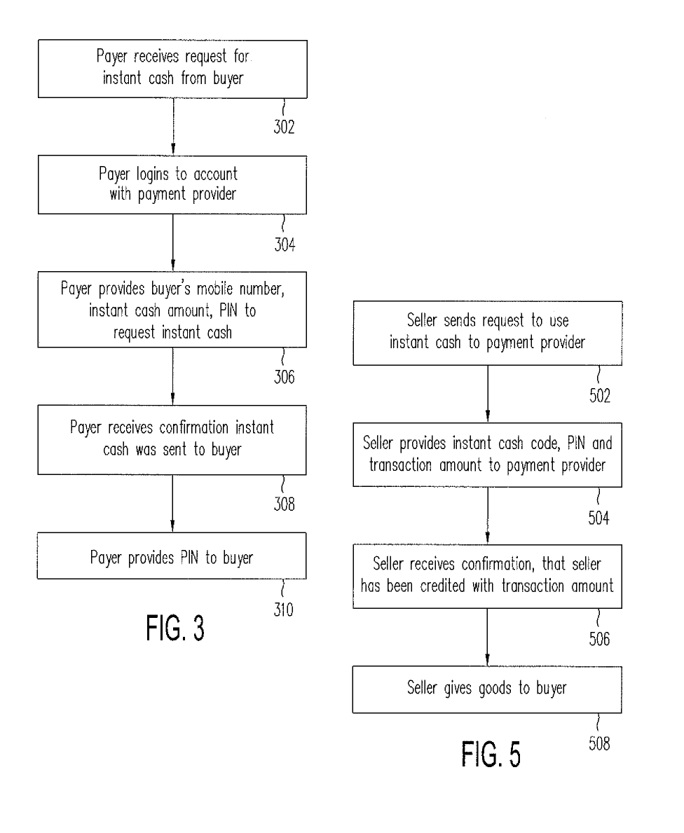

FIG. 3 shows a flow chart of the steps for an account holder of a payment service provider to request instant cash from the payment service provider for use by a buyer of FIG. 1 according to one or more embodiments of the present disclosure. In step 302, the account holder—payer 106, receives a request from buyer 100 to authorize funds from the payer's account with payment service provider 110 for use by buyer 100. Payer 106 may receive from buyer 100 the phone number, the IP address, or other identifier of mobile device 102 of buyer 100 and the amount of the requested funds. Buyer 100 and payer 106 may agree on a security code used to authenticate future use of the funds and may further agree on a validity period for the funds.

In step 304, payer 106 logins in his or her account with payment service provider 110 to request that funds be authorized for use by buyer 100. In one or more embodiments, payer 106 may use mobile device 108 to provide to payment service provider 110 the phone number, the IP address, or other identifier of mobile device 102 of buyer 100, the amount of funds requested, the security code, and the validity period for the funds, if any. In one or more embodiments, payment service provider 110 may communicate to buyer 100 through payer 106 so that payer 106 does not need to provide the information of buyer 100 to payment service provider 110. In one or more embodiments, payer 106 may not provide the amount of requested funds because payment service provider 110 may provide a set amount automatically. In one or more embodiments, payer 106 may not provide the security code if use of the funds is authenticated using other information, such as a device identifier of a device used to make a payment request. In one or more embodiments, payer 106 may not provide the validity period for the funds if payment service provider 110 sets the validity period to a default value. Payment service provider 110 may verify that payer 106 has sufficient funds in the payer's account or has a line or credit to cover the amount requested. After payment service provider 110 approves the request, payment service provider 110 may transmit a message to mobile device 102 of buyer 100 providing a coupon code that identifies the approved funds and information on the approved funds such as the amount and any validity period. In one or more embodiments, payment service provider 110 may transmit the message to mobile device 120 of payer 106, who then relays the message to mobile device 102 of buyer 100.

In step 308, payer 106 receives from payment service provider 110 a confirmation message on mobile device 108 confirming that funds have been approved for use by buyer 100. The message may contain information on the amount of the approved funds and the validity period, if any. In step 310, if not already known by buyer 100, payer 106 provides to buyer 100 the security code that will be used to authenticate the coupon code when buyer 100 requests use of the funds.

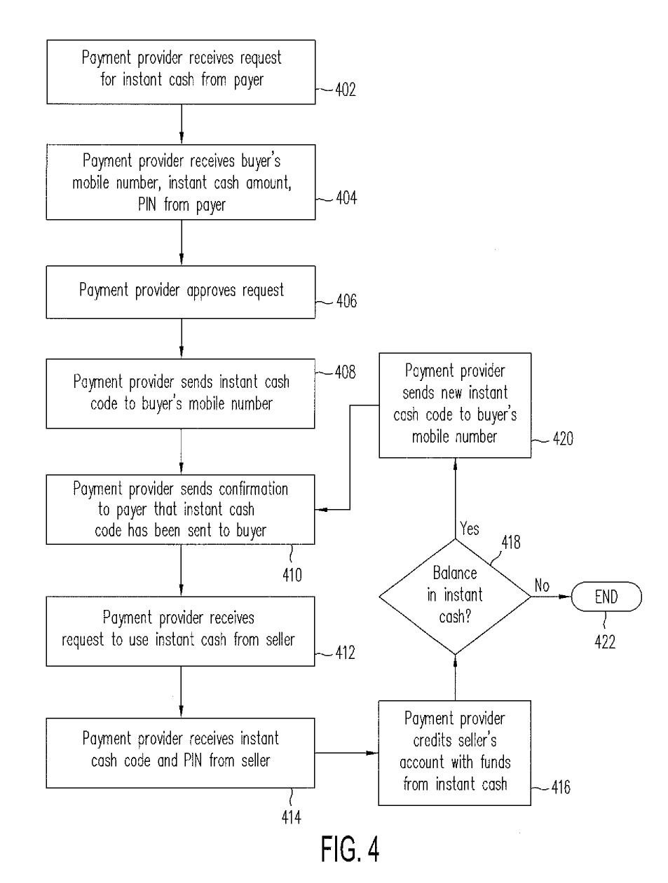

FIG. 4 shows a flow chart of the steps for a payment service provider to receive a request from an account holder to authorize instant cash for use by a buyer and to receive a request from a seller requesting approval for use of the instant cash by the buyer of FIG. 1 according to one or more embodiments of the present disclosure. In step 402, payment service provider 110 receives a request from an account holder—payer 106, requesting that funds be authorize for use by buyer 100. For example, payer 106 may login into his or her account on a website operated by payment service provider 110. Payment service provider 110 may receive the request through network interface 112 and may verify that payer 106 has an account by accessing account database 114.

In step 404, payment service provider 110 receives from payer 106 a phone number, an IP address, or other identifier of mobile device 102 of buyer 100, an amount of requested funds, a security code that will be used to authenticate future use of the funds, and a validity period for the funds, if any. In one or more embodiments, payment service provider 110 communicates to buyer 100 through payer 106 so that payment service provider 110 may not receive the information of mobile device 102 of buyer 100. In one or more embodiments, payment service provider 110 may not receive the amount of requested funds because payment service provider 110 may set an amount automatically. In one or more embodiments, payment service provider 110 may not receive the security code if use of the funds is authenticated using other information, such as a device identifier of a device used to make a payment request. In one or more embodiments, payment service provider 110 may not receive the validity period for the funds if payment service provider 110 sets the validity period to a default value. After payment service provider 110 verifies that payer 106 has sufficient funds in the account or has a line of credit to cover the amount requested, payment service provider 110 approves the requested amount in step 406. In one or more embodiments, if there are insufficient funds in the account or in the line or credit to cover the amount requested, payment service provider 110 may approve an amount reduced from the requested amount. In one or more embodiments, payment service provider 110 may cap the approve amount to a maximum amount. Payment service provider 110 may invoke instant cash management unit 116 to set aside the approved amount as instant cash for use by buyer 100. Instant cash management unit 116 may generate a coupon code such as a string of alpha-numeric code that is used to identify the instant cash and may associate the payer-provided security code with the coupon code for authentication purposes. Instant cash management unit 116 may configure the coupon code to have a validity period as requested by payer 106. For example, payer 106 may request that the instant cash identified by the coupon code be valid for only 24 hours from the time the instant cash is approved. At the end of the 24 hour period, the coupon code may expire and any unused balance in the instant cash may be credited back to the account of payer 106. In one or more embodiments, instant cash management unit 116 may configure the coupon code to have a default validity period in the absence of a validity period from payer 106.

In step 408, payment service provider 110 transmits to the phone number, the IP address, or other identifier of mobile device 102 of buyer 100 a message containing the coupon code and information on the instant cash identified by the coupon code, such as the approved amount and the validity period. In one or more embodiments, payment service provider 110 may transmit the message to payer 106, who then relays the message to buyer 100. In step 410, payment service provider 110 transmits a confirmation message to mobile device 108 of payer 106 to confirm that the instant cash has been approved and transmitted to buyer 100, and may further provide additional information on the amount of the instant cash approved.

In step 412, payment service provider 110 receives a request from a seller 118 for use of the funds from the instant cash as payment for a purchase. For example, buyer 100 may tender the coupon code identifying the instant cash and the security code associated with the coupon code to seller 118. If seller 118 has an account with payment service provider 110, seller 118 may login to the seller's account on the website operated by payment service provider 110. Payment service provider 110 may receive the request through network interface 112 and may verify that seller 118 has an account by accessing account database 114. If seller 118 does not have an account, seller 118 may be prompted to register an account. In step 414, after seller 118 is logged in, payment service provider 110 receives from seller 118 the coupon code, the security code, and the requested payment amount. Payment service provider 110 may invoke instant cash management unit 116 to authenticate the payment request by verifying that the security code is associated with the coupon code and that the coupon code is valid. In one or more embodiments, instant cash management unit 116 may authenticate the coupon code using a device identifier of mobile device 120 of seller 118, a point-of-sale terminal, or account information of seller 118 so that payment service provider 110 may not receive the security code from seller 118. Instant cash management unit 116 may further verify that the balance of funds in the instant cash is sufficient to cover the requested payment amount.

In step 416, if payment service provider 110 approves the request for use of the funds, instant cash management unit 116 deducts the requested payment amount from the balance in the instant cash and credits that amount to the account of seller 118. Payment service provider 110 may transmit a confirmation message to mobile device 120 of seller 118 to confirm that the requested payment amount has been credited to the account of seller 118. In step 418, instant cash management unit 116 determines if there is any balance in the instant cash after the deduction for the requested payment of step 416. For added security, if there is a balance in the instant cash, instant cash management unit 116 generates a new coupon code to identify the balance in the instant cash. The new coupon code may be associated with, and may be authenticated by, the same security code associated with the old coupon code for a subsequent payment request using the balance in the instant cash. In one or more embodiments, as with the old coupon code, the new coupon code may be associated with, and authenticated by, a device identifier of mobile device 120 of seller 118, a point-of-sale terminal, or account information of seller 118. In one or more embodiments, the validity period for the new coupon code is the remaining validity period of the original coupon code. Alternatively, the validity period for the new coupon code may be reset anew.

In step 420, payment service provider 110 transmits the new coupon code identifying the balance in the instant cash to mobile device 102 of buyer 100 and/or mobile device 108 of payer 106. Payment service provider 110 may transmit information on the remaining balance in the instant cash and the validity period of the new coupon to buyer 100 and/or payer 106. In step 410, payment service provider 110 may also transmit a confirmation message to mobile device 108 of payer 106 confirming that a new coupon code has been transmitted to buyer 100. Steps 412, 414, and 416 may be repeated to use the balance in the instant cash as payment for a new purchase. When the balance in the instant cash is exhausted or if the validity period for the coupon code has expired, use of the instant cash is terminated in step 422. In one or more embodiments, buyer 106 may terminate use of the instant cash at any time by canceling the coupon code.

FIG. 5 shows a flow chart of the steps for a seller to accept instant cash from a buyer for a purchase transaction of FIG. 1 according to one or more embodiments of the present disclosure. Seller 118 enters into a sale transaction with buyer 100, who desires to make payment using funds from instant cash by tendering to seller 118 a coupon code identifying the instant cash and the security code to seller 118. Seller 118 may receive the coupon code and the security code via mobile device 102, a point-of-sale terminal, or other types of communication devices. Seller 118 may receive the desired information from buyer 100 in any suitable format that allows seller 118 to read or otherwise capture the information. Examples include a sequence of numbers, characters, letter, and/or symbols or a machine readable image, such as a barcode or QR code. In step 502, seller 118 logins to the seller's account with payment service provider 110 to request payment from funds in the instant cash. In step 504, seller 118 transmits to payment service provider 110 the coupon code, the security code, and the requested payment amount. In one or more embodiments, seller 118 may not transmit the security code if the coupon code is not authenticated using the security code.

Payment service provider 110 approves the payment request by verifying that the security code is associated with the coupon code, that the coupon code is valid, and that the balance of funds in the instant cash is sufficient to cover the requested payment amount. In one or more embodiments, payment service provider 110 may authenticate the coupon code using a device identifier of mobile device 120 of seller 118, a point-of-sale terminal, or account information of seller 118. Payment service provider 110 deducts the requested payment amount from the balance in the instant cash and credits that amount to the account of seller 118. In step 506, seller 118 receives from payment service provider 118 a confirmation message on seller's mobile device 120 or the point-of-sale terminal confirming that the requested payment amount has been credited to the seller's account. In step 508, seller 118 completes the sale transaction by handing the goods to buyer 100 if the sale transaction is for purchase of goods.

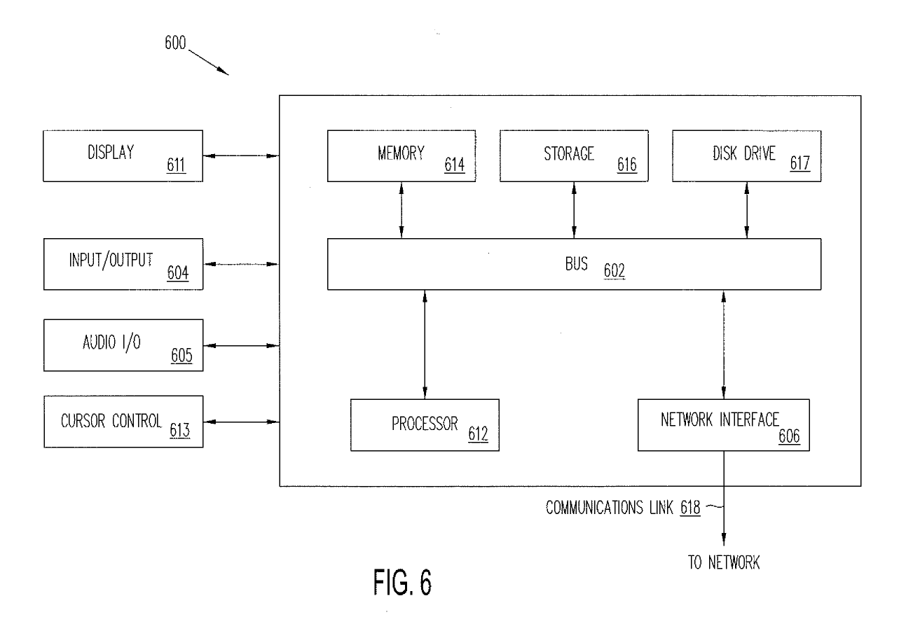

FIG. 6 is a block diagram of a computer system 600 suitable for implementing one or more embodiments of the present disclosure. In various implementations, the mobile device of the user may comprise a personal computing device (e.g., smart phone, a computing tablet, a personal computer, laptop, PDA, Bluetooth device, key FOB, badge, etc.) capable of communicating with the network. The seller and/or payment provider may utilize a network computing device (e.g., a network server) capable of communicating with the network. It should be appreciated that each of the devices utilized by users, sellers, and payment providers may be implemented as computer system 600 in a manner as follows. It should also be appreciated that the toll-free number and the services to accept orders, manage inventories, and process payments may be implemented as applications running on computer system 600.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component such as a display 611, and an input control such as a cursor control 613 (such as a keyboard, keypad, mouse, etc.). An optional audio input/output component 605 may also be included to allow a user to use voice for inputting information by converting audio signals into information signals. Audio I/O component 605 may allow the user to hear audio. A transceiver or network interface 606 transmits and receives signals between computer system 600 and other devices, such as another user device, a seller server, or a payment provider server via a communication link 618 to a network. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment service provider to administer the toll-free number and the services to accept orders, manage inventories, and process payments, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a method is described for a buyer to use instant cash from a payment service provider as a payment source, the method may be extended to use a line of credit, a loan, or other types of financial instruments. Similarly, even though a payment service provider is described as providing the instant cash, other entities, including banks or other types of financial institutions, may provide the source of funds. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

1. An apparatus of a service provider comprising:
a network interface configured to communicate with devices over a network;
a memory configured to store a plurality of machine-readable instructions;
one or more processors configured to execute the machine-readable instructions to:
receive from a payer, who has an account with the service provider, a funding request to authorize funds from the account of the payer for use by a buyer;
process the funding request;
generate a first coupon code used to identify the funds associated with the account of the payer;
transmit to the buyer or the payer the first coupon code;
receive a payment request to transfer a payment amount from the funds associated with the account of the payer to an account of a seller, wherein the payment request comprises the first coupon code;
verify the first coupon code to approve the payment request;
transfer the payment amount from the funds associated with the account of the payer to the account of the seller;
notify the seller;
generate a second coupon code used to identify a balance in the funds if the balance remains after the payment amount from the funds is transferred to the seller; and
transmit to the buyer or the payer the second coupon code.

2. The apparatus of claim 1, wherein the funding request comprises contact information of the buyer for the processors to transmit to the buyer the first coupon code using the contact information.

3. The apparatus of claim 1, wherein the funding request comprises a funding request amount for the funds.

4. The apparatus of claim 1, wherein the funding request comprises a security code, wherein the security code is associated with the first coupon code for authentication purposes.

5. The apparatus of claim 4, wherein the payment request comprises an authentication code, and wherein the processors verify the first coupon code to approve the payment request when the authentication code matches the security code associated with the first coupon code.

6. The apparatus of claim 1, wherein the first coupon code has a validity period, and wherein the processors verify that the payment request is received during the validity period to approve the payment request.

7. The apparatus of claim 6, wherein if there is a balance in the funds after the validity period of the first coupon code, the processors are further configured to transfer the balance in the funds to the account of the payer.

8. The apparatus of claim 1, wherein if the seller does not have an existing account with the service provider, the processors are further configured to establish the account of the seller to receive the payment amount.

9. (canceled)

10. The apparatus of claim 1, wherein the processors are further configured to receive a new payment request to use the balance in the funds, wherein the payment request comprises the second coupon code.

11. A method comprising:
receiving by a processor of a service provider a funding request from a payer to authorize funds for use by a buyer, wherein the payer has an account with the service provider;
processing by the processor the funding request;
generating by the processor a first coupon code used to identify the funds associated with the account of the payer;
transmitting to the buyer or the payer the first coupon code;
receiving a payment request to transfer a payment amount from the funds associated with the account of the payer to an account of a seller, wherein the payment request comprises the first coupon code;
verifying the first coupon code to approve the payment request;
transferring the payment amount from the funds associated with the account of the payer to the account of the seller;
notifying the seller;
generating a second coupon code used to identify a balance in the funds if the balance remains after the payment amount from the funds is transferred to the seller; and
transmitting to the buyer or the payer the second coupon code.

12. The method of claim 11, wherein the funding request comprises contact information of the buyer for use by said transmitting to the buyer the first coupon code.

13. The method of claim 11, wherein the funding request comprises a funding request amount for the funds.

14. The method of claim 11, wherein the funding request comprises a security code, wherein the security code is associated with the first coupon code for authentication purposes.

15. The method of claim 14, wherein the payment request comprises an authentication code, and wherein said verifying the first coupon code to approve the payment request comprises matching the authentication code to the security code associated with the first coupon code.

16. The method of claim 11, wherein the first coupon code has a validity period, and wherein said verifying the first coupon code to approve the payment request comprises verifying that the payment request is received during the validity period.

17. The method of claim 16, wherein if there is a balance in the funds after the validity period of the first coupon code, further comprising transferring the balance in the funds to the account of the payer.

18. (canceled)

19. The method of claim 11, further comprising receiving a new payment request to use the balance in the funds, wherein the payment request comprises the second coupon code.

20. A non-transitory computer readable medium having computer readable code for instructing a processor of a service provider to perform a method, the method comprising:
receiving a funding request from a payer to authorize funds for use by a buyer, wherein the payer has an account with the service provider;
processing the funding request;
generating a first coupon code used to identify the funds associated with the account of the payer;
transmitting to the buyer or the payer the first coupon code;
receiving a payment request to transfer a payment amount from the funds associated with the account of the payer to an account of a seller, wherein the payment request comprises the first coupon code;
verifying the first coupon code to approve the payment request;
transferring the payment amount from the funds associated with the account of the payer to the account of the seller;
notifying the seller;
generating a second coupon code used to identify a balance in the funds if the balance remains after the payment amount from the funds is transferred to the seller; and
transmitting to the buyer or the payer the second coupon code.
